(19) United States
(12) Patent Application Publication
(10) Pub. No.: US 2016/0207716 A1
(43) Pub. Date: Jul. 21, 2016

(54) POST-PACKAGING OVERHEAD COORDINATION CONVEYOR

(71) Applicant: AMITEC OY, Laitila (FI)

(72) Inventors: Reino Yli-Piipari, Laitila (FI); Paul Loska, Laitila (FI); Kari Seppä, Laitila (FI); Jouni Järvinen, Laitila (FI); Veikko Kormano, Laitila (FI)

(21) Appl. No.: 14/914,852

(22) PCT Filed: Aug. 15, 2014
(86) PCT No.: PCT/FI2014/050631

§ 371 Date: Feb. 26, 2016

(30) Foreign Application Priority Data
Aug. 27, 2013 (FI) 20135861

(51) Int. Cl. B65G 43/00; B65G 47/90; B65G 35/00

(52) U.S. Cl. CPC B65G 43/00; B65G 35/00; B65G 47/902

(57) ABSTRACT

The present invention provides a conveyor arrangement for removing a self-rolling load carrier from a production line, the conveyor arrangement allowing transport corridor that is safe and easy to clean. The conveyor arrangement comprises means for forming a safety area on the passage corridor (30) of the load carriers (40). The said means are arranged to detect the presence of a foreign object on the passage corridor (30) and in case of detection to stop the movement of the conveyor. The conveyor arrangement also comprises a coordinate conveyor (10) arranged above the load carrier (40) to transport the load carrier (40) away from the production line (20), whereby the floor of the safety area (30) is free of conveyors, i.e. there's free space in the production lines in the direction of movement.

### CROSS-REFERENCE TO RELATED APPLICATIONS

This application is entitled to the benefit of and incorporates by reference subject matter disclosed in the International Patent Application No. PCT/FI2014/050631 filed on Aug. 15, 2014 and Finnish Patent Application No. 20135861 filed on Aug. 27, 2013.

### TECHNICAL FIELD

The present invention relates to logistics. The invention especially relates to an automated post-packaging conveyor arrangement.

### BACKGROUND

Manufacturing lines of production facilities are typically planned to produce a final packaged product that is ready to be stored or transported further to the next step of the delivery chain. Thus the packaging apparatus usually is the last apparatus of the production line processing the product, packaging the products to the load carrier for transporting. Thousands of various kinds of load carriers are known, but typically in production industry pallets are used and they are moved by means of e.g. fork trucks, and self-rolling load carriers, such as roll containers or dollies. Usually self-rolling load carriers, i.e. ones provided with wheels, are handled by means of conveyors built as an extension of the production line, the conveyors gripping the load carrier and transporting it and its products to the next handling step.

Let us next review as an example a dairy that in a typical case has a number of parallel production lines. The packaging apparatus of each parallel production line loads the packaged milk products into the roll container which is fed to the receiving conveyor.

Having received a filled roll container the conveyor, such as a chain conveyor with grippers, transports it along the floor of the production facility towards the cold storage. Usually the grippers of the conveyors are arranged to grip the roll container so that the roll container travels on chains, whereby the roll container can be moved and temporarily stored.

Sometimes there, however, is a need to move roll containers, such as empty containers, crosswise in relation to the production line. The need can arise as e.g. a back-up operation in case of manual feed or when removing a damaged roll container from the system. Moving the roll containers on an automatized conveyor corridor can be difficult to do safely due to the conveyors installed on the area of the passage corridor of the roll container. Additionally the known conveyor arrangements make it difficult to keep the transport corridor clean, which is disadvantageous specially in dairy applications.

### SUMMARY

Thus, the aim of at least some embodiments of the present invention is to provide a conveyor arrangement for removing a self-rolling load carrier from a production line, the conveyor arrangement allowing a safe and easy to clean transport corridor.

The aim of at least some embodiments of the invention is achieved by means of a novel conveyor arrangement comprising means for forming a safety area on the passage corridor of the load carriers. The said means are arranged to detect the presence of a foreign object on the passage corridor and in case of detection to stop the movement of the conveyor. The conveyor arrangement also comprises a coordinate conveyor arranged above the load carrier to transport the load carrier away from the production line, whereby the floor of the safety area is free of conveyors, i.e. there's free space in the production lines in the direction of movement.

The aim of at least some embodiments of the invention is achieved on one hand by means of a novel method for transporting a self-rolling load carrier from the production line, in which method the load carrier is gripped at the end of the production line by a coordination transporter located above the load carrier, the load carrier is transported to outside the production line.

Considerable advantages are achieved by means of at least some embodiments of the invention. As the passage corridor of the load carriers is free of conveyors, a crosswise movement between production lines is easy and it is easy to keep the area clean.

According to one embodiment the passage corridor is protected by a light curtain arranged to interrupt the movement of the coordination transporter as the beam of the light curtain is interrupted, whereby it is very simple to form an efficient safety area.

### BRIEF DESCRIPTION OF THE DRAWINGS

In the following, embodiments of the invention are reviewed in more detail by means of reference to the appended drawings, in which:

FIG. 1 shows a conveyor arrangement according to one embodiment of the invention,

FIG. 2 shows a conveyor arrangement according to FIG. 1 in which the gripper has gripped the load carrier,

FIG. 3 shows a conveyor arrangement according to FIG. 1 in which a movable object has been rotated about its vertical axis,

FIG. 4 shows a conveyor arrangement according to FIG. 1 in the longitudinal slide has been driven to its extreme position, and

FIG. 5 shows a conveyor arrangement according to FIG. 1, in which the longitudinal slide is carrying out a return movement to the packaging apparatus.

### DETAILED DESCRIPTION

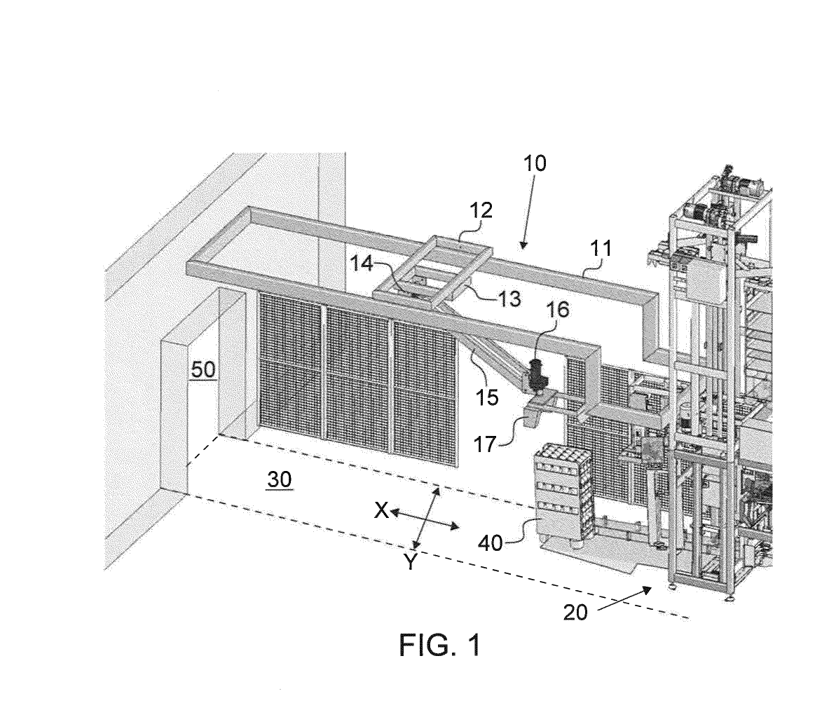

As is shown in FIGS. 1 to 5, the conveyor arrangement according to the invention can be arranged in connection with the production line 20 for transporting the self-rolling load carrier 40 away from the production line. In more detail, a special application of the conveyor arrangement is a production line in which the load carrier arriving from the end of the packaging apparatus must be forwarded to outside 50 the production line 20. A dairy can be mentioned as an example of an application, wherein a packaging apparatus is packing milk vessels into a roll container 40, with a need to seamlessly transport the milk vessels to the cold storage 50. It is, however, obvious that the conveyor arrangement according to the invention is applicable to a number of different production lines and to a number of different self-rolling, i.e. wheeled load carriers. According to one embodiment the load carrier 40 is a roll container. According to another embodiment the load carrier 40 is a dolly or a stack of boxes provided with one. Other self-rolling load carriers 40 are also possible.

Still referring to FIG. 1 it can be seen that having arrived from the end of the production line the load carriers 40 are transported to outside the production line 50 in transport direction X, here called longitudinal direction. A coordination conveyor 10 has been arranged above the load carrier 40 being transported in the transport arrangement. The coordination conveyor 10 comprises longitudinal guides 11 arranged parallel with the transport direction X above the height of the load carrier 40, whereby the passage corridor is unobstructed. The longitudinal guides 11 are located at a height of at least 2500 mm from the floor for forming an advantageous free space. A longitudinal slide 12 is movably arranged in the longitudinal guides 11, the slide being arranged in a transverse direction in relation to transport direction X between the longitudinal guides 11 similar to portal cranes. The longitudinal slide 12 is driven by means of electric motors (not shown) or corresponding suitable means.

Thus, at its simplest, the coordination conveyor 10 can be carried out by means of a longitudinal slide 12, onto which is hung a gripper 17 connecting to the load carrier 40 by means of e.g. wires, whereby the load carrier 40 can be towed by the longitudinal slide 12.

The coordination conveyor 10 is provided with a crosswise slide 13 arranged movably to the longitudinal 12 so that the crosswise slide 13 can be driven crosswise in relation to the longitudinal direction X. In other words the crosswise slide 13 can be driven in crosswise direction Y. The crosswise slide 13 is driven by electric motors (not shown) or other suitable means. Thus cooperation of the longitudinal and crosswise slides 12, 13 allows the coordination conveyor 10 to make planar coordination transports on the area of the passage corridor.

The coordination conveyor 10 is provided with a manipulation means for moving the load carrier 40. The manipulation means comprises an arm 15, the first end of which is connected to the coordination conveyor 10, in more detail to the crosswise slide 13, the first end of which is provided with a gripper 17. In other words, the arm 15 is attached to the longitudinal slide 12 in an articulated manner via the crosswise slide 13. The first end of the arm 15 is connected to the crosswise sled 13 in an articulated manner so that the angular position of the arm 15 is changed in relation to the longitudinal guides 11, i.e. horizontal level. Thus the coordination conveyor 10 is provided with a height rotator 14 arranged between the crosswise slide 13 and the first end of the arm 15 for connecting these together via articulation. The height rotator 14 is an electric motor or other corresponding manipulator.

According to one embodiment the arm 15 is a telescopic arm (not shown) for improving the positioning of the gripper.

As stated above, one end of the arm 15 is provided with a gripper 17 arranged to connect to the load carrier 40 for moving it. In this context the connecting to the load carrier 40 is to be understood functionally so that the gripper 17 connects to the object to be moved, whereby the gripper 17 grips the load carrier 40 (such as a roll container) or the load carried by the load carrier 40 (such as a stack of boxes on top of a dolly. Thus the gripper 17 is an object-specific means. In the example of FIGS. 1 to 5 the gripper 17 is arranged to grip a dairy roll container 40 from above. The gripper 17 can also be arranged to connect to the backside of the load carrier 40, i.e. the side facing the production line 20, but even in this case the gripping would be carried out from above. Thus gripping from above is to be understood functionally so that the gripper 17 approaches the movable object from above and grips it from any side, for example from above.

The gripper 17 is arranged on one end of the arm 15 in an articulated manner via a side rotator 16. The side rotator 16 can be provided with e.g. an electric motor attached to other end of the arm 15 and the shaft of which is connected to the gripper 17 for rotating it in relation to the vertical axis, whereby the gripper 17 is rotatable in side direction, i.e. on horizontal level. A turning joint can also be provided between the side rotator 16 and one end of the arm 15 for producing additional movement dimensions (not shown), It naturally possible to arrange additional turning joints between other components of the coordination conveyor 10, such as between the crosswise slide 13 and the arm 15. It is, however, possible to avoid unnecessary turning joints to minimize sensitivity to disturbances and the need for service.

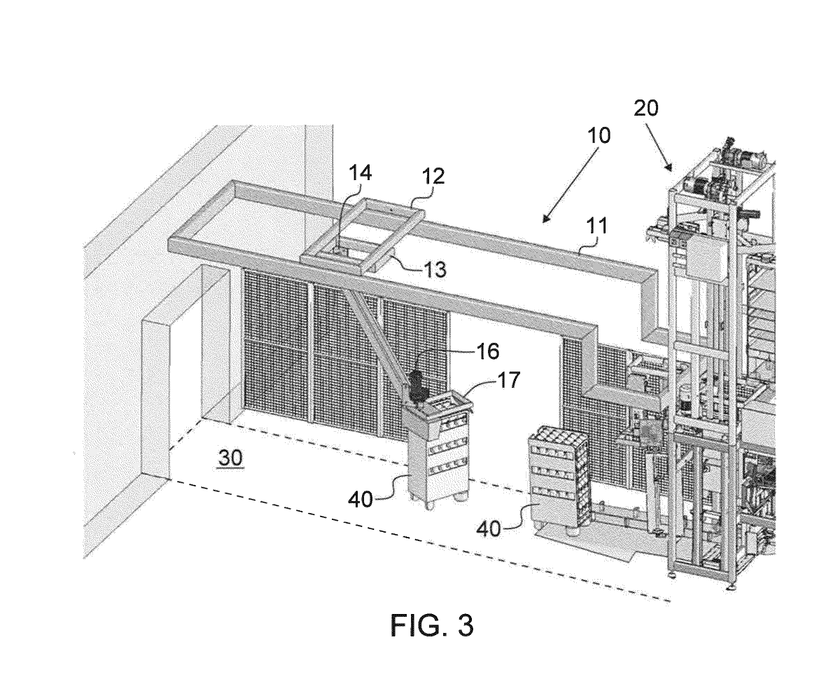

Thus the coordination conveyor 10 is arranged to remove the load carrier 40 from the production line 20 to an outside area 50. The location of the load carrier 40 in longitudinal direction X can be changed by driving the longitudinal slide 12 along the longitudinal guides 11. Correspondingly the location of the load carrier 40 in crosswise direction Y can be changed by driving the crosswise slide 13 along the longitudinal slide 12. By changing the angular position of the arm 15 the gripper 17 can be driven to contact the load carrier 40 that can be moved in longitudinal direction X by further changing the angular position. The position of the load carrier 40 can be changed in relation to the vertical axis by rotating the gripper 17 by means of side rotator, whereby the load carrier 40 can be, for example rotated around (see FIG. 3). Thus the coordination conveyor 10 is arranged to grip the load carrier 40 above it and to push it along the passage corridor 30 to outside 50 the production line 20.

According to one embodiment the gripper 17 is arranged to connect to the load carrier 40 so that it can be lifted off the floor, whereby the load carrier 40 can be removed from the production line 20 by carrying it in the air. However, a self-rolling load carrier 40 is moved along the floor for simplifying the structure of the coordination conveyor 10.

The coordination conveyor 10 also comprises control means and a number of sensors that are known per se and not critical for the present invention. Therefore the control means and functional sensors of the coordination conveyor 10 are not described in detail in this disclosure.

The longitudinal direction X and its crosswise direction Y form the passage corridor 30 in the area of movement of the coordination conveyor. The conveyor arrangement comprises means for forming a safety area on the passage corridor 30 of the load carriers 40, the means being arranged to detect the presence of a foreign object in the passage corridor 30 and in case of presence to stop the movement of the conveyor. According to one embodiment the safety area is formed by means of light curtains, which are known per se. Thus the coordination conveyor 10 is provided with a light curtain (not shown) connected to the control means of the coordination conveyor 10, the control means being arranged to interrupt the movement of the coordination conveyor as the beam of the light curtain is interrupted. The conveyor arrangement is arranged to mute and activate the safety curtain automatically, when the coordination conveyor 10 operates the in the area of the light curtain. Similarly, when the load carrier 40 arrives at the end 50 of the passage corridor 30, the conveyor arrangement is arranged to mute the safety curtain, whereby the load carrier 40 can be moved to outside 50 the passage corridor 30, e.g. to a cold storage. Thereby the gripper 17 can safely release the load carrier 40 to be moved and return to the production line 20 to fetch the next roll container.

Alternatively the means for forming a safety area can be arranged by means of other kinds of proximity switches or by means of, e.g. pressure sensors along the edges of the passage corridor 30.

According to an embodiment the coordination conveyor 10 is also provided with a proximity switch for monitoring the front of the gripper 17. The said proximity switch can be arranged to, for example, the longitudinal slide 12. Therefore the safety apparatus of the coordination conveyor 10 monitors the direction of travel of the load carrier 40 to be moved. If there's an obstruction in front of the load carrier 40, the apparatus slows down and finally stops, if the obstruction has not moved out of the way.

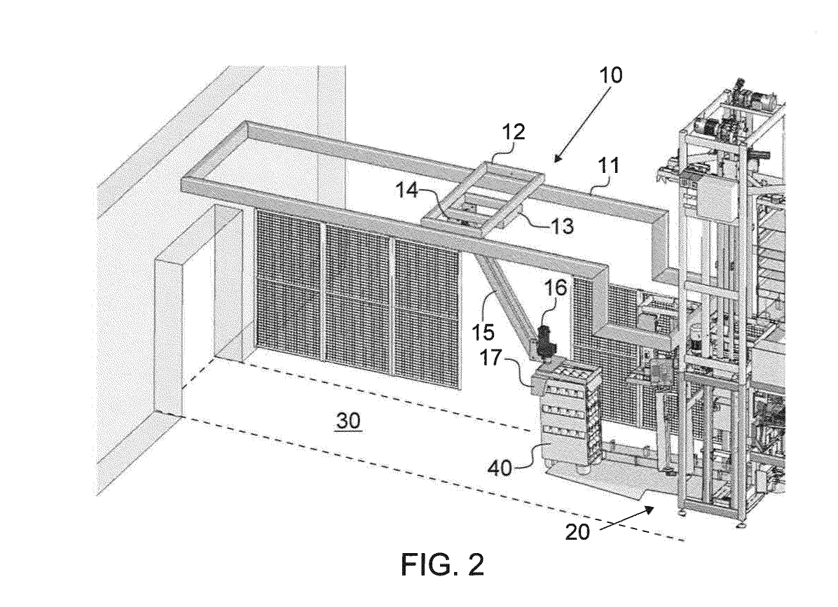

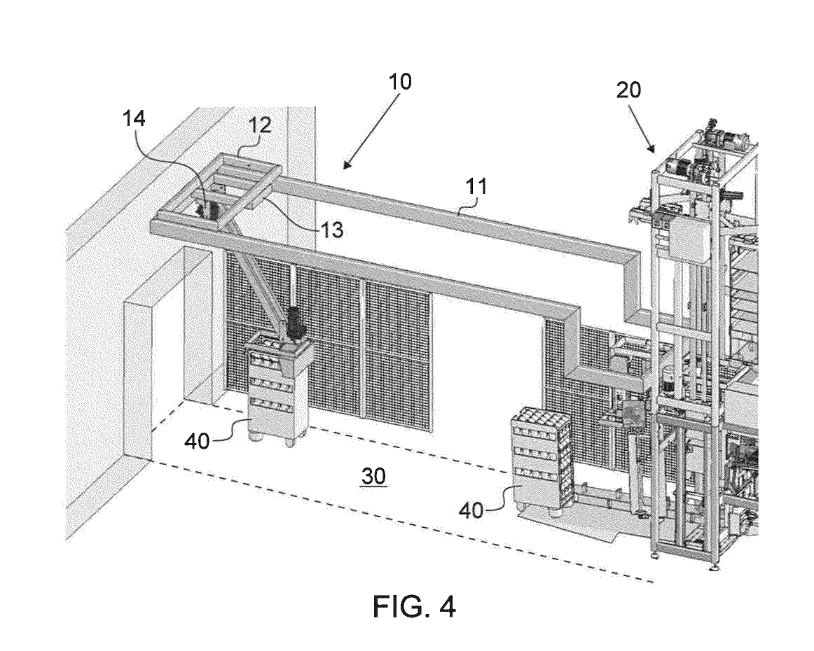

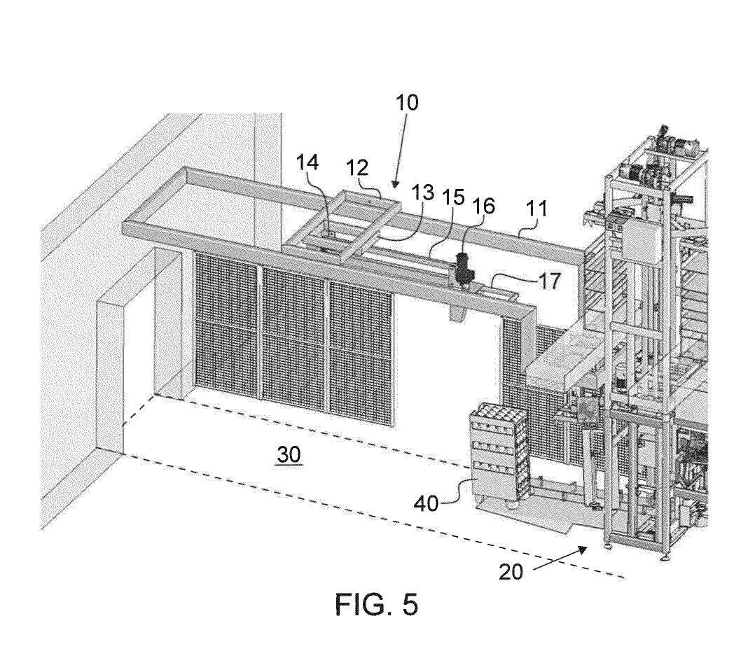

In operation the longitudinal slide of the coordination conveyor 10 is in the first end position and the gripper 17 locks to the self-rolling load carrier 40 while it is in the packaging apparatus of the production line 20 before the passage corridor 30, i.e. the safety area (FIGS. 1 and 2). In case the load carrier 40 must be rotated over, the gripper 17 is rotated by means of the side rotator 16 in relation to the vertical axis (FIG. 3). The load carrier 40 is moved away from the production line 20 towards an outside area 50 by driving the longitudinal slide 12 in longitudinal direction (FIG. 4). When the load carrier 40 is transported away from the production line 20, the arm 15 is lifted up by swiveling it to horizontal position by means of the height rotator 14, whereby the longitudinal slide 12 can be driven back to the end of the production line 20 (FIG. 5). Thereby the passage corridor 30 is free of conveyors in both longitudinal and crosswise directions. The gripper 17 or other lowest actuator means of the coordination conveyor is arranged to rise to a height of over 2500 mm over the floor surface, whereby the conveyor does not interfere with other operations on floor level.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A conveyor arrangement for removing a self-rolling load carrier from a production line, the conveyor arrangement comprising:
a conveyor configured to move a load carrier away from the production line, and
means for forming a safety area on a passage corridor for the load carriers, the means being arranged to detect the presence of a foreign object on the passage corridor and to stop the movement of the conveyor in case of presence,
wherein the conveyor is a coordinate conveyor located above the load carrier, whereby the floor of the passage corridor is free of conveyors.

2. The conveyor arrangement according to claim 1, wherein the coordination conveyor is arranged to grip the load carrier from above it and to push the self-rolling load carrier along the passage corridor to outside the production line.

3. The conveyor arrangement according to claim 1, wherein the coordination conveyor comprises:
longitudinal guides located above the load carrier,
a longitudinal slide arranged movably in the longitudinal guides, and
a gripper connected to the longitudinal slide and arranged to grip the load carrier in order to move it.

4. The conveyor arrangement according to claim 3, wherein the coordination conveyor comprises an arm connected to the longitudinal slide in an articulated manner and to the free end of which the gripper is arranged.

5. The conveyor arrangement according to claim 4, wherein the coordination conveyor comprises a crosswise slide movably arranged to the longitudinal slide, whereby the arm is connected to the longitudinal slide in an articulated manner via the crosswise slide.

6. The conveyor arrangement according to claim 5, wherein the coordination conveyor comprises a side rotator arranged between the free end of the arm and the gripper so that the gripper can be manipulated in relation to the arm.

7. The conveyor arrangement according to claim 1, wherein the safety area is formed by means of a light curtain configured to interrupt the movement of the coordination conveyor, when the beam of the light curtain is interrupted.

8. The conveyor arrangement according to claim 7, wherein the coordination conveyor is configured to mute and activate the safety curtain automatically, when the coordination conveyor operates in the area of the light curtain.

9. A method for transporting a self-rolling load carrier from a production line, the method comprising:
gripping the self-rolling load carrier at the end of the production line, and transporting the self-rolling load carrier to outside the production line by means of a coordination conveyor located above the load carrier, which coordination conveyor is configured to grip the load carrier from above.

10. The method according to claim 9, wherein the load carrier is transported by means of a conveyor arrangement.

11. The conveyor arrangement according to claim 2, wherein the coordination conveyor comprises:
longitudinal guides located above the load carrier,
a longitudinal slide arranged movably in the longitudinal guides, and
a gripper connected to the longitudinal slide and arranged to grip the load carrier in order to move it.

12. The conveyor arrangement according to claim 1, wherein the conveyor arrangement is constructed to remove a self-rolling load carrier from a production line.

13. The conveyor arrangement according to claim 6 wherein the conveyor arrangement is constructed to remove a self-rolling load carrier from a production line.

14. The conveyor arrangement according to claim 8, wherein the conveyor arrangement is constructed to remove a self-rolling load carrier from a production line.

15. The conveyor arrangement according to claim 2, wherein the safety area is formed by means of a light curtain configured to interrupt the movement of the coordination conveyor, when the beam of the light curtain is interrupted.

16. The conveyor arrangement according to claim 3, wherein the safety area is formed by means of a light curtain configured to interrupt the movement of the coordination conveyor, when the beam of the light curtain is interrupted.

17. The conveyor arrangement according to claim 4, wherein the safety area is formed by means of a light curtain configured to interrupt the movement of the coordination conveyor, when the beam of the light curtain is interrupted.

18. The conveyor arrangement according to claim 5, wherein the safety area is formed by means of a light curtain configured to interrupt the movement of the coordination conveyor, when the beam of the light curtain is interrupted.

19. The conveyor arrangement according to claim 6, wherein the safety area is formed by means of a light curtain configured to interrupt the movement of the coordination conveyor, when the beam of the light curtain is interrupted.
